(19) United States
(12) Patent Application Publication
(10) Pub. No.: US 2018/0204481 A1
(43) Pub. Date: Jul. 19, 2018

(54) METHOD OF CREATING AND DISTRIBUTING DIGITAL DATA SETS TO IMPROVE PERFORMANCE OF PHYSICAL ACTIVITIES

(71) Applicant: Behzad Nejat, Cupertino, CA (US)

(72) Inventor: Behzad Nejat, Cupertino, CA (US)

(21) Appl. No.: 15/408,435

(22) Filed: Jan. 18, 2017

(51) Int. Cl. G09B 19/00; G09B 5/02; A63B 71/06; A63B 24/00; A63B 43/00; A63B 69/00; H04N 13/02; G06K 9/62; G06K 9/46

(52) U.S. Cl. CPC G09B 19/0038; A63B 2243/007; G09B 5/02; A63B 71/0622; A63B 24/0006; A63B 43/004; A63B 69/0071; A63B 69/00; A63B 69/004; A63B 24/0075; H04N 13/0203; G06K 9/6202; G06K 9/4604; A63B 2071/0625; A63B 2024/0015; A63B 2220/803; A63B 2220/807; A63B 2220/806; A63B 2220/833; A63B 2244/22; A63B 2244/10; A63B 2243/0037; G09B 19/0015

(57) ABSTRACT

The present invention relates to a system and method of creating and distributing digital data sets for performing physical activities. A method consistent with the present invention includes capturing at least one digital representation of each body position during the execution of an activity. The activity involves one or more physical movements. Additionally, converting the digital representations of each body position associated with the activity to digital data sets. The digital data sets comprise at least one joint coordinate or bone orientation at discrete time periods during the execution of the activity.

### FIELD

The present invention relates to a system and method of creating and distributing digital data sets to improve performance of physical activities.

### BRIEF DESCRIPTION OF THE DRAWINGS

To facilitate understanding, identical reference numerals have been used, wherever possible, to designate identical elements that are common to the figures. The drawings are not to scale and the relative dimensions of various elements in the drawings are depicted schematically and not necessarily to scale. The techniques of the present invention may readily be understood by considering the following detailed description in conjunction with the accompanying drawings, in which:

FIG. 1 is a smart basketball equipped with electronics for tracking movement data.

FIG. 2 is a smart football equipped with electronics for tracking movement data.

FIG. 3 is a motion-sensing device system having a console, joystick, and tripod mounting assembly.

FIG. 4 is an internal view of a motion-sensing device console consistent with the present invention.

FIG. 5 is an illustration for tracking movement and providing recommendations to players on a basketball court.

FIG. 6 is a series of screenshots of a professional basketball player, with skeletal diagram overlays, going through the motion of shooting a basketball.

FIG. 7 is a series of screenshots with skeletal diagram screenshots of a professional basketball player going through the motion of shooting a basketball.

FIG. 8 is a series of screenshots of the progression of a basketball in the course of a shot.

FIG. 9 is an illustration of a system for tracking movement and providing recommendations during the execution of martial arts moves on a smart mat.

FIG. 10 is an illustration of a pressure map obtained from a smart mat consistent with a system and method of the present invention.

FIG. 11 is a flowchart for a method of storing digital representations associated with the performance of one or more physical movements.

FIG. 12 is a flowchart for a method of storing digital data associated with the performance of physical movements associated with an activity.

FIG. 13 is an illustration of an individual receiving feedback from a motion-sensing device console during physical therapy.

FIG. 14 is an illustration of a walking motion which may be represented by digital data sets in a manner consistent with the present invention.

FIG. 15 are illustrations of sitting postures that are represented by digital data sets in a manner consistent with the present invention.

FIG. 16 is an illustration of a pair of dancers in a dance pose which may be represented by digital data sets in a manner consistent with the present invention.

FIG. 17 is an illustration of a data set associated with a specific physical movement.

FIG. 18 are illustrations of three representations of digital data sets associated with three exemplary physical activities.

FIG. 19 are illustrations of digital data sets of the performance of a physical activity associated with a first individual and a second individual.

### DETAILED DESCRIPTION

Before the present invention is described in detail, it is to be understood that, unless otherwise indicated, this invention is not limited to specific procedures or articles, whether described or not.

It is further to be understood that the terminology used herein is for the purpose of describing particular embodiments only and is not intended to limit the scope of the present invention.

It must be noted that as used herein and in the claims, the singular forms “a,” and “the” include plural referents unless the context clearly dictates otherwise.

Where a range of values is provided, it is understood that each intervening value, to the tenth of the unit of the lower limit unless the context clearly dictates otherwise, between the upper and lower limit of that range, and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure. The term “about” generally refers to ±10% of a stated value.

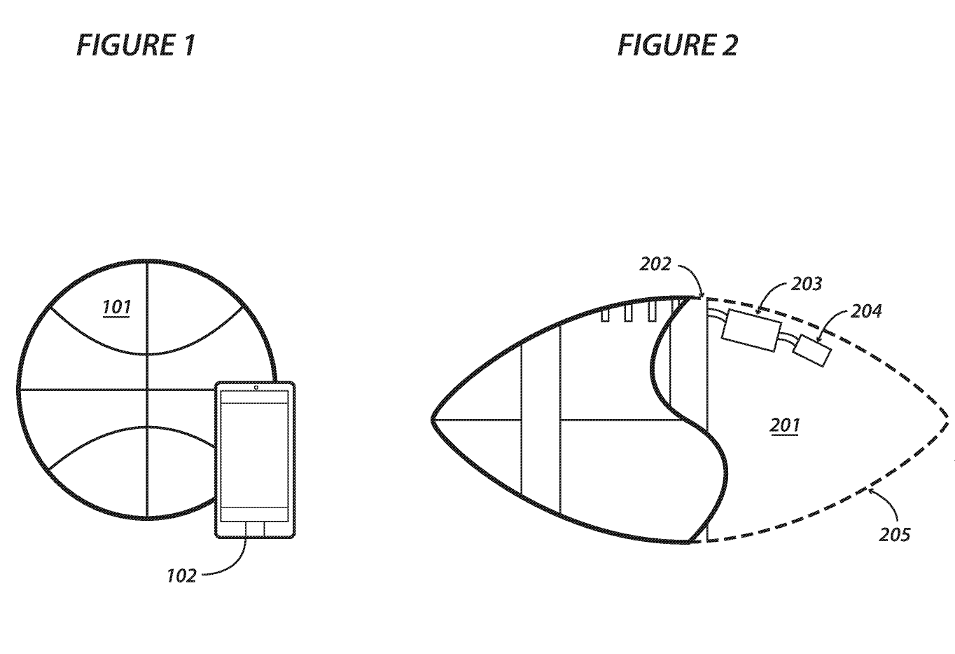

FIG. 1 is a smart ball (e.g., smart basketball 101) equipped with electronics (not shown) for tracking movement data. It should be known by those having ordinary skill in the art that sports equipment may be embedded with electronics. As such, the present invention employs such technology to obtain data associated therewith to provide performance recommendations, etc.

Exemplary electronics may include, but is not limited to, an accelerometer, a gyroscope, a transmitter, a receiver, and any other component known in the art to measure the smart basketball's 101 velocity (angular, lateral, and vertical), acceleration, rotation, orientation, or any other property. In addition, the smart basketball 101 may further have sensors to measure the forces or pressures exerted thereon.

In some implementations, a mobile device 102 such as a smartphone may be communicatively coupled to smart basketball 101 (or any other smart ball 101). Mobile device 102 may transmit or receive information from smart basketball 101. For instance, a transmitter component of smart basketball 101 may send movement data to mobile device 102 based upon a pre-determined frequency.

FIG. 2 is a smart football 201 equipped with electronics for tracking movement data. Smart football 201 is another example of a smart ball 201 that is consistent with the spirit and scope of the present invention. Particularly, an inside portion (denoted by dotted lines 205) of the smart football 201 shows representations of electrical components 203, 204. In some embodiments, smart football 201 has electrical components 203, 204 confined to one side (see demarcation point 202) such that a user can effectively throw the smart football 201 without obstruction.

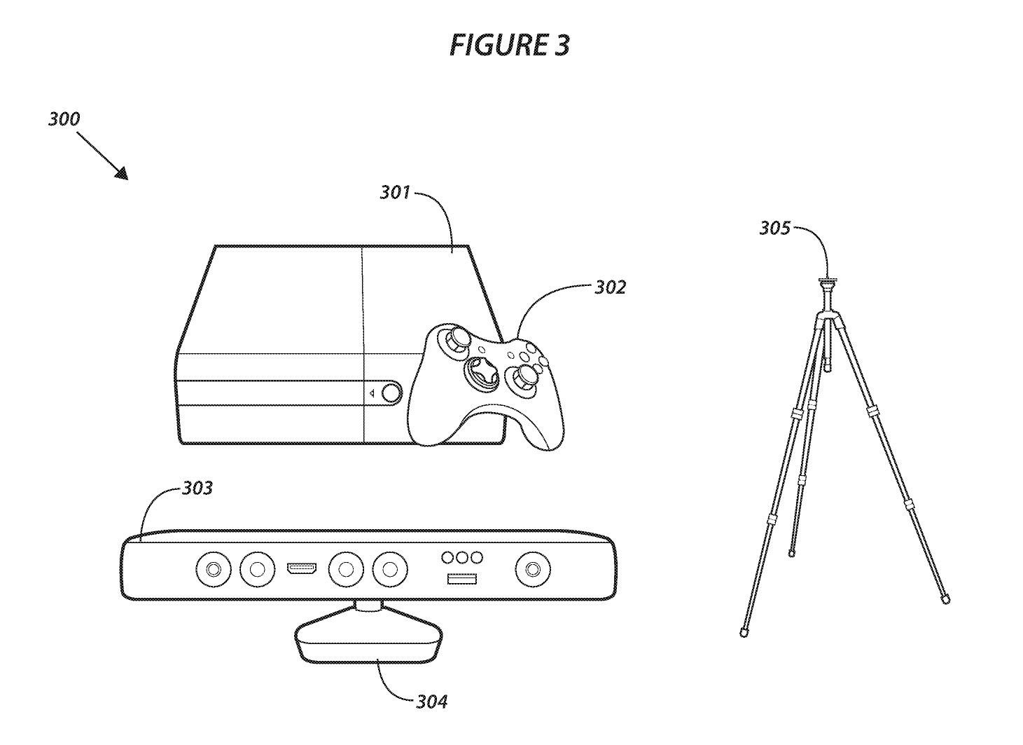

FIG. 3 is a motion-sensing device system 300 having a console 301, joystick 302, and tripod mounting assembly 305. Motion-sensing device console 301 may be employed by a user to retrieve movement data of the user while executing an activity. As will be described in detail below, motion-sensing device console 301 can output signals to inform user(s) that a movement or set of movements associated with an activity is being (or has been) performed correctly.

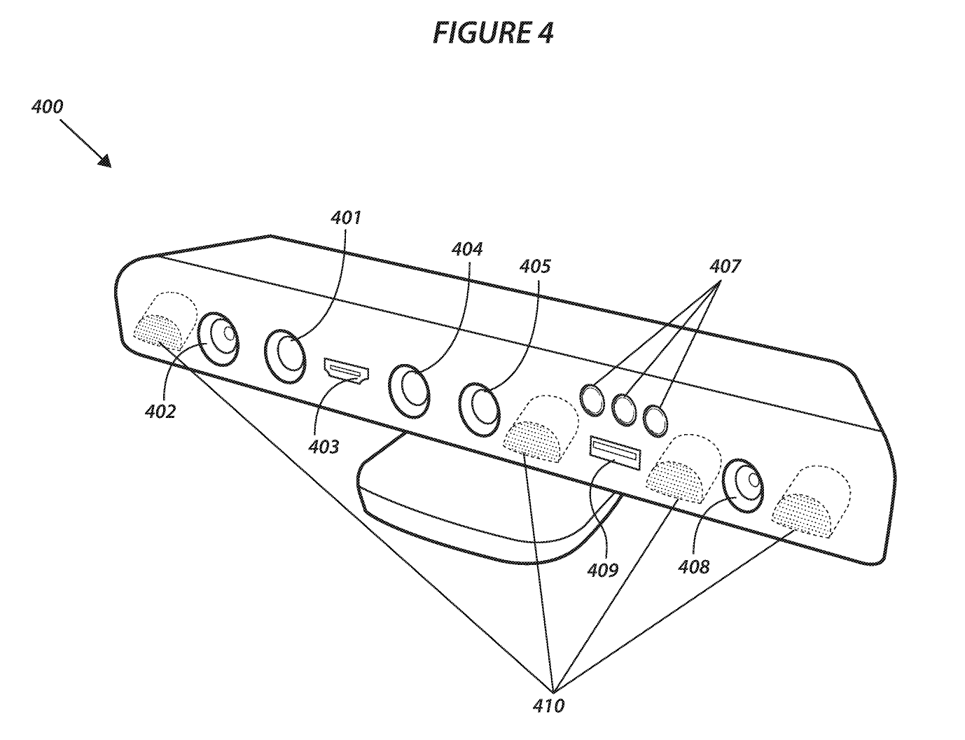

FIG. 4 is an internal view of a motion-sensing device console 400 consistent with the present invention. Motion-sensing device console 400 includes an infrared (IR) emitter 401, a RBG camera 404, an IR depth sensor 405, a multi-mic array 410, a tilt motor 406, a set of speakers 402, 408, an HDMI input 403, a USB input 409, and other devices. Motion-sensing device console 400 can capture images of physical activities, in real time, and track and convert these images to digital data.

Tilt motor 406 may be used to adjust the tilt angle of the motion-sensing device console 400 to more effectively capture a user's performance of various physical activities.

RGB camera 404 can function as a basic webcam to record an area of activity. RGB camera 404 can capture images of normal video speeds (e.g., 30 fps) and may therefore project images at a suitable resolution (e.g., 640×480). RGB camera 404 may rely on infrared light to function.

IR emitter 401 is a source of light energy in the infrared spectrum. RGB camera 404 can detect infrared light waves that bounce off people and objects in the area that the user is in. IR emitter 401 and RGB camera 404 are capable of capturing a colored image and depth of each pixel in the scene. Therefore, the brighter the light, the closer the object is to the motion-sensing device console 400.

The data fed in by RGB camera 404 can be processed by software and used to identify human body-part shapes (e.g., heads and limbs). Motion-sensing device console 400 can be programmed with many human poses and therefore anticipate various body movements. This capability may be essential in two-person activities in which there may be obstructions from time to time during a session.

Motion-sensing device console 400 may be programmed to use structured light and machine learning. To infer body positions, a two-stage process is implemented. First, a depth map is computed and then body positions are inferred using machine learning.

Motion-sensing device console 400 may be configured to combine structured light by two techniques: 1) depth from focus and 2) depth from stereo. The depth map may be constructed by analyzing a speckle pattern of infrared laser light. Body parts may be inferred using a randomized decision forest learned from many training examples.

Multi-mic array 410 may be employed to conduct acoustic source localization and ambient noise suppression. In some embodiments, multi-mic array 410 allows for headset play.

HDMI input device 403 may be employed as a proprietary audio/video interface for transferring uncompressed video data and compressed/uncompressed digital audio data from an HDMI-compliant source device, such as a display controller, to a compatible computer monitor, video projector, digital television, or digital audio device. USB input 409 can connect, communicate, or provide power to electronic devices with the motion-sensing device console 400.

Once the representations are converted to digital data, this data may be transmitted (e.g., uploaded via wireless communication over the Internet) to a computing system (e.g., cloud server) which compares the transmitted digital data with a plurality of pre-stored data associated with a specific physical movement (e.g., athletic movement).

Based on the comparison, the computing system may transmit (via an output device) one or more performance recommendations based on a plurality of pre-defined rules. One may therefore improve their ability to perform the physical activity by taking heed to the given recommendations. A network may be established such that other computing devices (e.g., laptop) may access the digital data associated with the captured data.

In some embodiments, the plurality of pre-stored digital data may be referred to as “digital data sets.” Digital data sets may include digital representations of joint coordinates and/or bone orientations at discrete time periods or frames (which may be a unit of time) during the execution of physical movement(s) associated with an activity. In some embodiments, the digital data sets represent the most optimal, efficient, and correct manner that the activity should be performed.

For example, the digital data sets may represent the physical movements associated with an athletic movement. Another example may include digital data sets which digitally represent the physical movements of a professional dancer performing a dance move. As such, individuals which perform activities at a high-level (e.g., professionally) may be used as test subjects to create digital data sets for the benefit of other individuals who desire to improve their performance for any given activity that requires physical movement.

Motion-sensing device console 400 can also include output devices to provide feedback (e.g., visual, audible, etc.) to users. For example, when motion-sensing device console 400 detects that the user is performing the physical movement correctly, the device console 400 may output a light indicator 407 (e.g., green). Alternatively, when motion-sensing device console 400 detects that the user is performing the physical activity incorrectly, the device console 400 can output a light indicator 407 (e.g., red). In alternative embodiments, speakers 402, 408 can output an audible signal in response to a user's performance of one or more physical movements.

It should be understood by one having ordinary skill in the art that output indicators emitted by motion-sensing device console 400 is not limited to visual indicia. As such, various other output indicators known in the art may be employed. For example, motion-sensing device console 400 may employ a first audible alert to indicate that the physical activity is being (or has been) performed correctly whereas a second audible alert may be emitted to indicate that the physical activity is being (or has been) performed incorrectly. In some embodiments, digital representations may be extrapolated from a still picture or video stream using a digital camera according to one or more embodiments of the present disclosure.

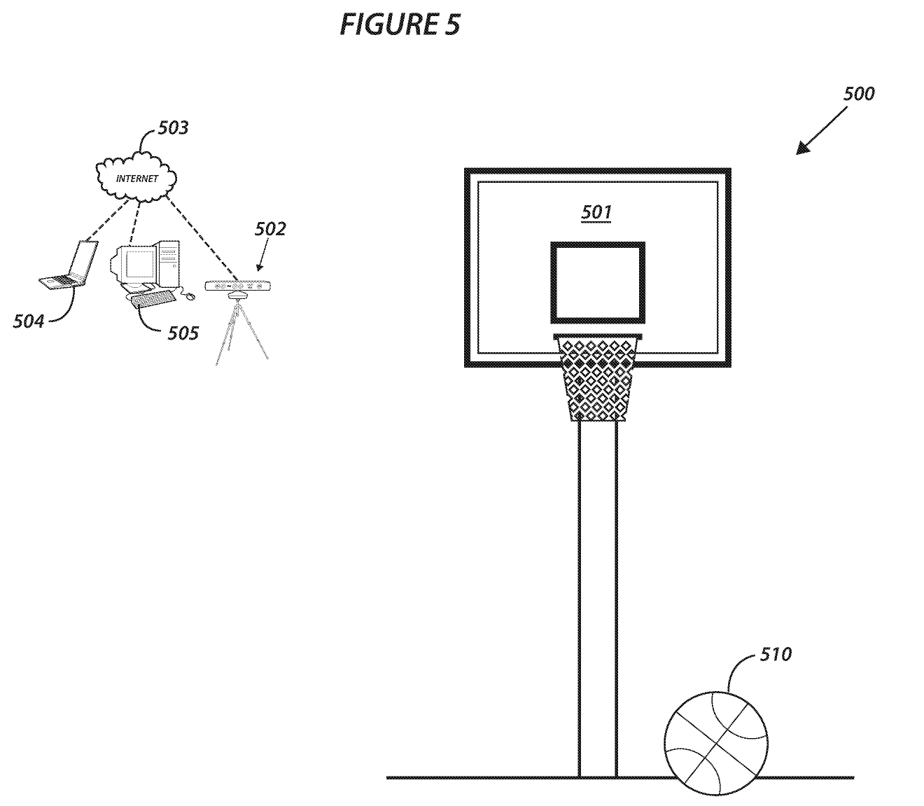

FIG. 5 is an illustration 500 of a system for tracking movement and providing recommendations to players on a basketball court. As shown, a motion-sensing device console 502 can track and capture motion data associated with physical movement associated with one or more activities.

Notably, motion-sensing device console 502 can capture movement data associated with a basketball player while shooting hoops. Motion-sensing device console 502 can respond with performance recommendations based on the player's prior performance. Basketball 510 may also be a smart ball as described above.

When motion-sensing device console 502 detects that the player is shooting the basketball 510 correctly, the device console 502 can output a first indicator (e.g., green). Alternatively, when motion-sensing device console 502 detects that the player is shooting basketball 510 incorrectly, the device console 502 may output a second indicator (e.g., red).

It should be understood by one having ordinary skill in the art that the output indicators emitted by motion-sensing device console 502 is not limited to visual indicia. As such, various other output indicators known in the art may be employed. For example, motion-sensing device console 502 can employ a first audible alert to indicate that the physical activity (e.g., shooting a basketball) is or has been performed correctly whereas a second audible alert can be emitted to indicate that the physical activity is or has been performed incorrectly.

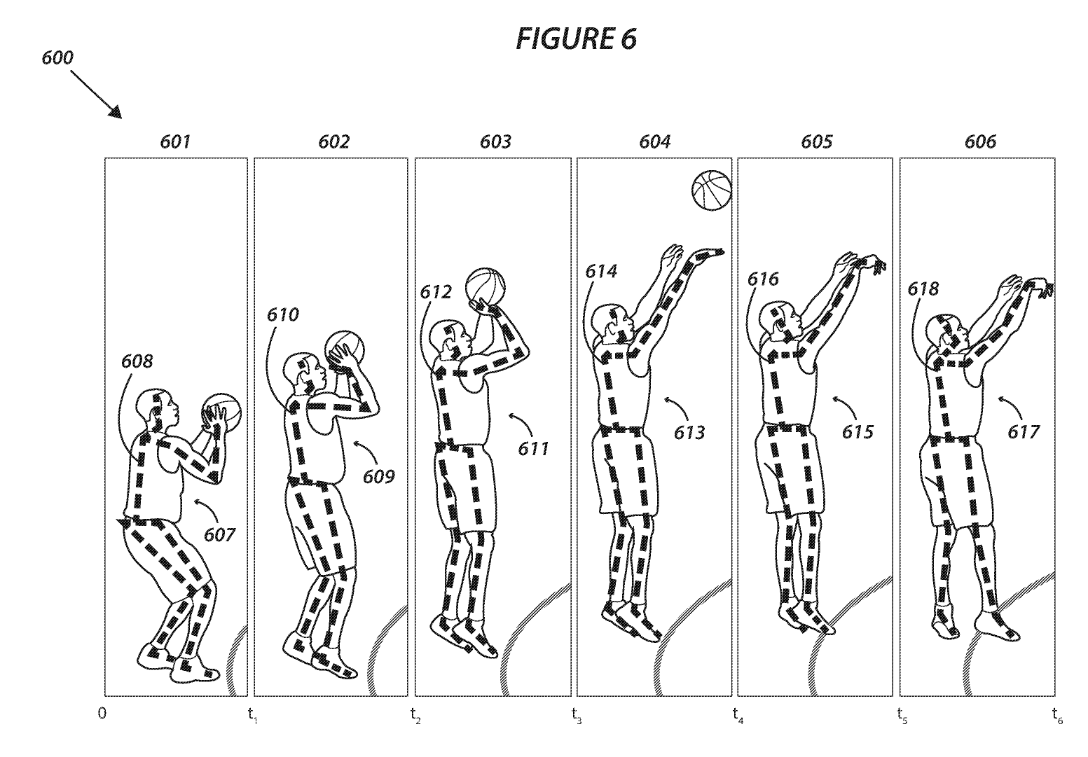

FIG. 6 is a series of screenshots 600 of a professional basketball player, with skeletal diagram overlays, going through the motion of shooting a basketball. The series of screenshots 600 may be captured by a motion-sensing device console consistent with the present invention.

A motion-sensing device console consistent with the present invention may include a camera component. In alternative embodiments, a novel motion-sensing device console described herein can include a discrete camera device communicatively coupled thereto.

Screenshot 601 (0-t₁) displays the basketball player in an initial position 607 poised to take a shot. As shown in the figure, a skeletal diagram 608 is overlaid on the image of the basketball player. It should be understood by one having ordinary skill in the art that skeletal diagram 608 has a unique structure and therefore digital data associated therewith is unique thereto.

Moving forward, screenshot 602 (t₁-t₂) shows the basketball player in a second position 609 and a skeletal diagram 610 associated therewith. It should be understood by one having ordinary skill in the art that skeletal diagram 610 has a unique structure and therefore digital data associated therewith is also unique.

Screenshot 603 (t₂-t₃) shows the basketball player in a third position 611 and a skeletal diagram 612 associated therewith. Skeletal diagram 612 has a unique structure and therefore digital data associated therewith is also unique.

Moving forward, screenshot 604 (t₃-t₄) shows the basketball player in a fourth position 613 and a skeletal diagram 614 associated therewith. As shown, the fourth position 613 may be characterized at the peak of the basketball player's shot. Skeletal diagram 614 has a unique structure and therefore digital data associated therewith is also unique.

Next, screenshot 605 (t₄-t₅) shows the basketball player in a fifth position 615 and a skeletal diagram 616 associated therewith. The basketball player's fifth position 615 depicts the apex of the basketball player after the ball is released from the player's hand. Skeletal diagram 616 has a unique structure and therefore digital data associated therewith is also unique.

Lastly, FIG. 6 displays screenshot 606 which depicts the basketball player 617 in a follow through motion after the ball is released from the player's hand. It should be understood by one having ordinary skill in the art that the correct follow through of a physical movement may be important to the execution of said physical activity. Accordingly, in some embodiments, the digital data sets may include digital representations of the follow-through phase of the activity.

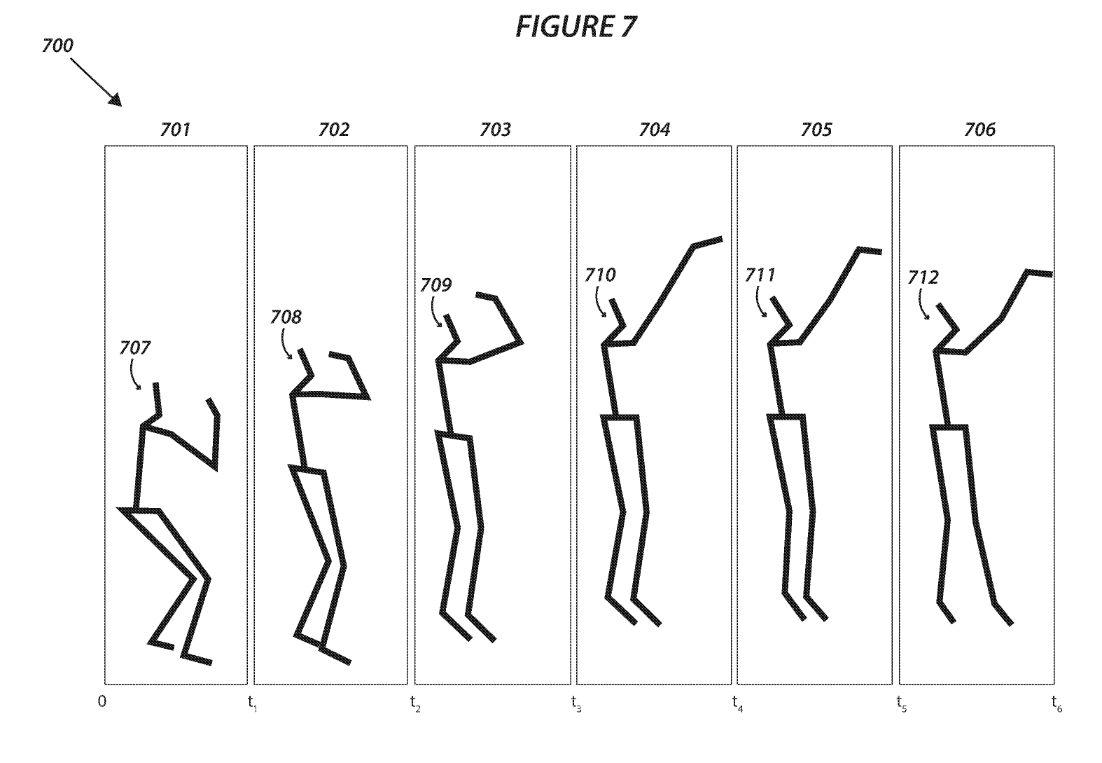

FIG. 7 is a series of skeletal diagram screenshots of a professional basketball player going through the motion of shooting a basketball. It should be understood that the screenshots in FIG. 7 correspond to the illustrations depicted in FIG. 6.

Screenshot 701 (0-t₁) shows the skeletal diagram 707 of the basketball player in a first position (e.g., at the beginning of the shot). Likewise, screenshots 702-706 depict illustrations of skeletal diagrams 708-712 during the progression of the basketball player's shot as shown in the screenshots of FIG. 6.

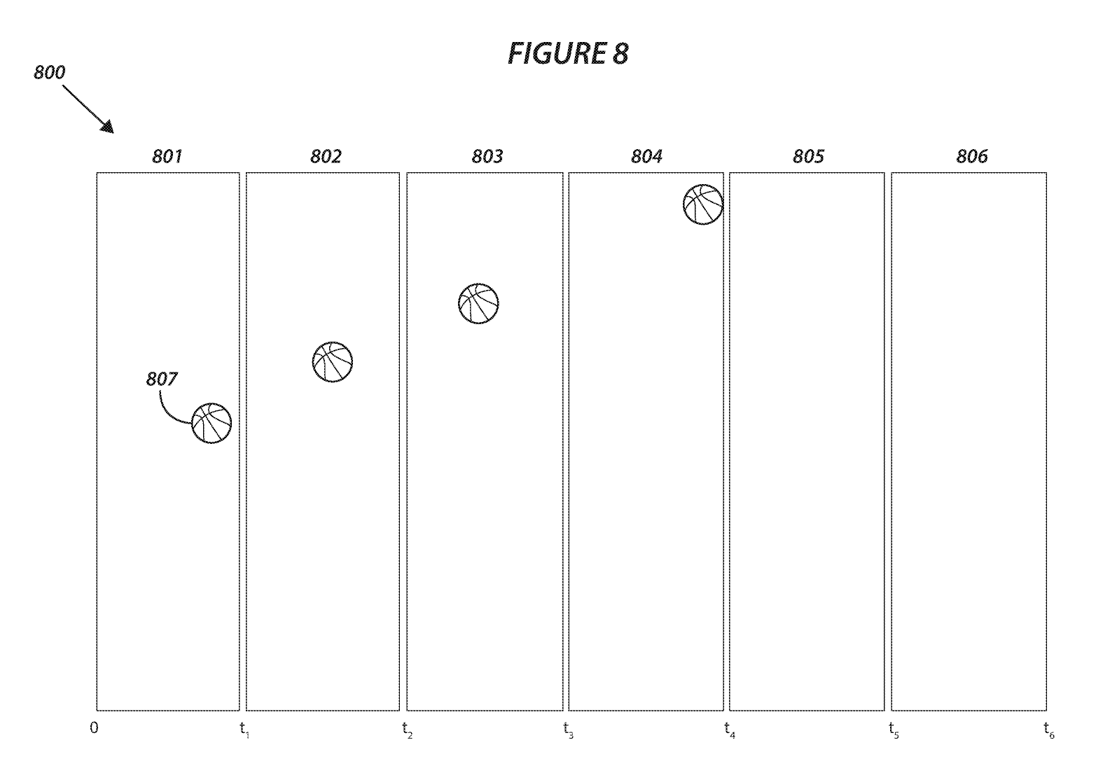

FIG. 8 is a series of screenshots 801-806 of the progression of a basketball 807 during the course of a shot. It should be understood that the screenshots in FIG. 8 corresponds to the illustrations depicted in FIG. 6. As described above, images of basketball 807 may be captured by a motion-sensing device console. Likewise, digital data associated with the ball's 807 path during the shot may be tracked, captured, and digitally transmitted to an external server.

The digital data associated with the ball 807 may be compared with pre-stored digital data associated with shooting a basketball under similar conditions (e.g., shooting a free throw, three-pointer, etc.). Advantageously, one may review the digital data associated with the basketball's motion data to improve their performance.

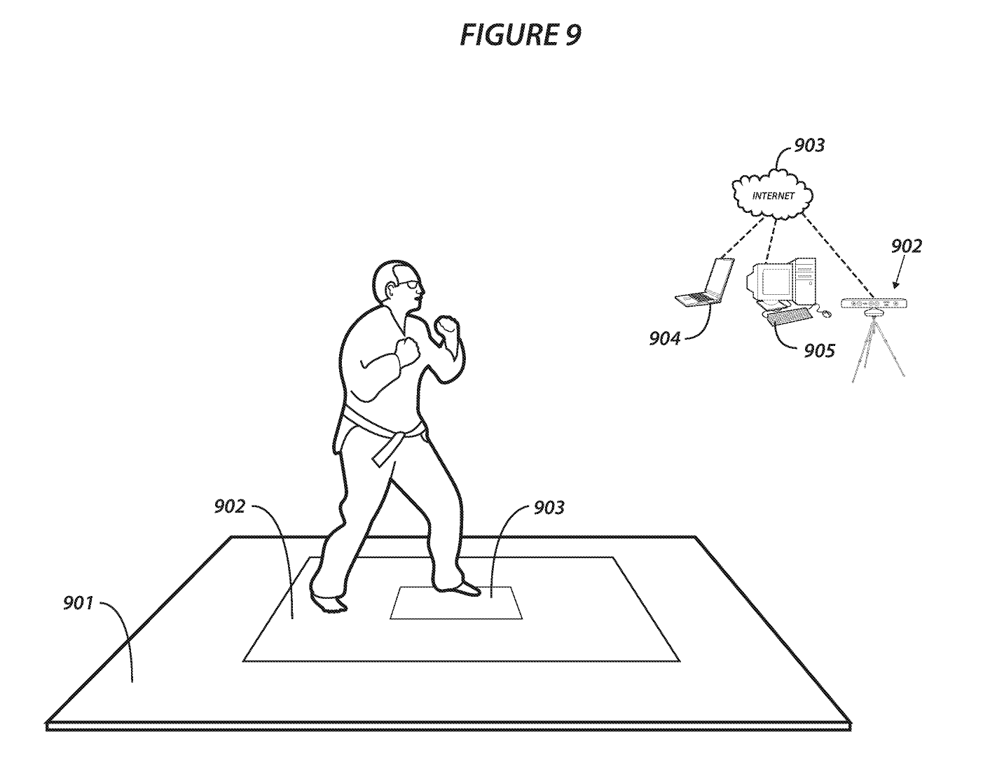

FIG. 9 is an illustration of a system for tracking movement and providing recommendations during the execution of martial arts moves on a smart mat 901. Motion-sensing device console 900 may be placed in a position to capture the individual's movements.

Notably, smart mat 901 comprises pressure sensors which obtain pressure data while a user performs physical activities (e.g., martial arts moves) thereon. The captured data may be digitized and distributed (e.g., over the Internet) to an external computing device which can compare this data with pre-stored digital data associated with specific martial arts moves. As previously discussed, motion-sensing device console 900 can generate recommendations based on the digitized movement data.

In the figure, smart mat 901 has two or more regions 902a, 902b but the present invention is not limited thereto. Regions 902a, 902b of smart mat 901 may vary by quantity and type but may be configured to retrieve specific types of data. In addition, data captured by these sensors may be fed to the motion-sensing device console 900 or other computing system by any suitable means known in the art.

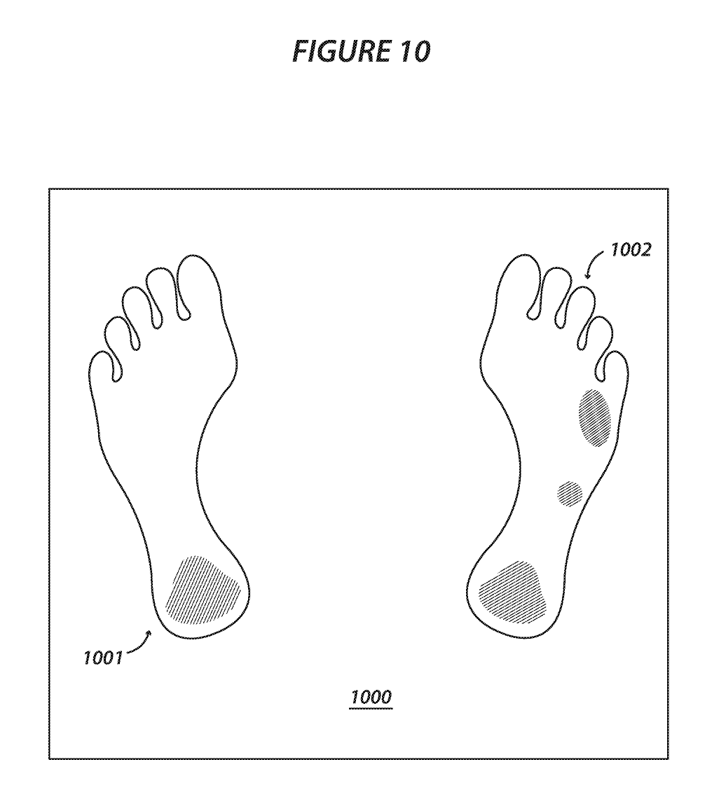

FIG. 10 is an illustration of a pressure map 1000 obtained from a smart mat (see FIG. 9) consistent with a system and method of the present invention. Pressure map 1000 displays images associated with the pressures or forces detected at distinct areas at discrete time periods (or frames) during the execution of the activity. It should be understood by those having ordinary skill in the art that the present invention is not limited to a pressure map 1000 to display pressure data but may also employ force maps or any other metric.

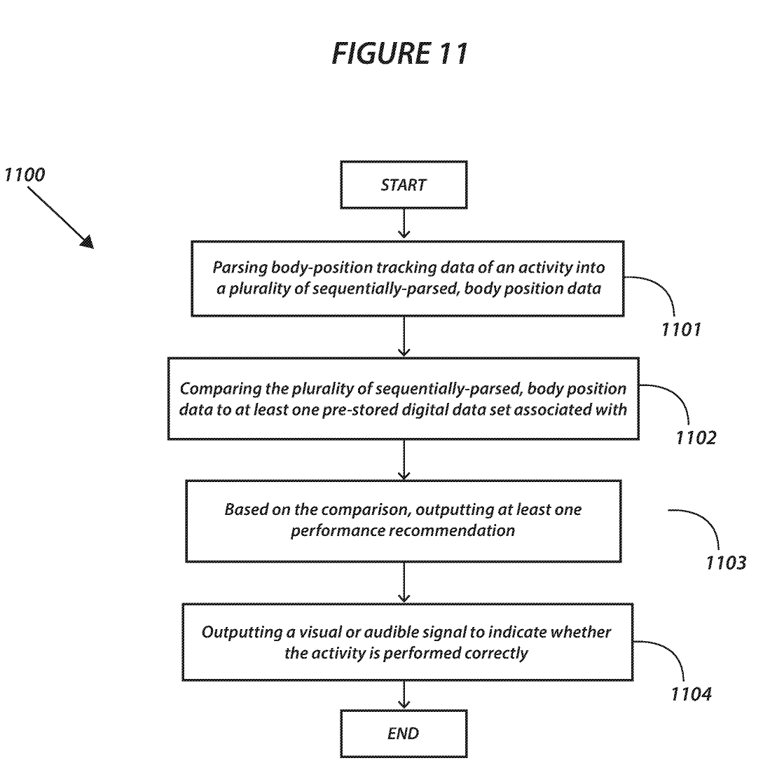

FIG. 11 is a flowchart 1100 for a method of body-position tracking and processing consistent with the present invention. Flowchart 1100 begins with parsing body-position tracking data of an activity into a plurality of sequentially-parsed, body position data (block 1101). Next, comparing the plurality of sequentially-parsed, body position data to at least one pre-stored digital data set associated with the activity (block 1102).

The at least one pre-stored digital data set represents a closest match to a pre-defined movement in a database. Based on the comparison, outputting at least one performance recommendation (block 1103). The performance recommendations include graphics that illustrate an overlay of a plurality of joint coordinates or bone orientations associated with the plurality of sequentially-parsed, body-position data and the pre-stored data associated with the performed activity. Next, outputting visual or audible signals to indicate whether the activity is performed correctly (block 1104).

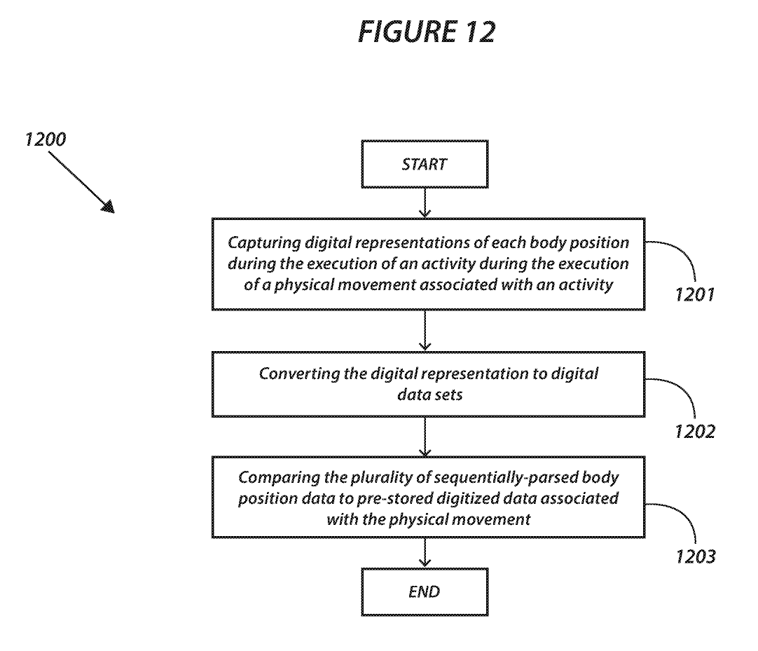

FIG. 12 is a flowchart 1200 for a method of storing digital data associated with the performance of physical movements associated with an activity. Flowchart 1200 begins with capturing digital representations of a plurality of joint coordinates and/or bone orientations associated with an individual during the execution of a physical movement associated with an activity (block 1201). The activities may be related to dancing postures, rehabilitation routines, or basic movement patterns (e.g., in-situ human ambulatory movement). Digital representations of these activities may be captured and digitized as described herein.

Next, converting the digital representation to digital data sets (block 1202). The digital data sets comprise joint coordinates and/or bone orientations at discrete time periods during the execution of the activity.

Accordingly, a user may obtain digital data sets of their body positions during the execution of one or more physical movements. In some implementations, professionals within a particular genre (e.g., sports) may have digital data sets created from their body positions for any particular activity. These digital data sets may then be used as the standard to which others attempt to imitate. Individuals may obtain the digital data sets of professionals via a download from the Internet or by any other suitable means. A database consistent with the present disclosure may have a multitude of digital data sets representing many activities for which vary by age, race, gender, body type, etc.

The present invention may include a database of digital data sets associated with the correct manner to execute a physical movement associated with an activity. However, the present invention may further employ a database that includes digital data sets associated with sub-standard execution of a physical activity.

For example, digital data sets may be created for a correct manner of rolling a bowling ball by using the motion-sensing device console. Motion-sensing device console can be used to capture multiple test subjects, of varying demographics (e.g., adults, teenagers, males, females, short, tall, underweight, average weight, overweight, etc.), rolling a bowling ball.

Finally, comparing the plurality of sequentially-parsed body position data to pre-stored digitized data associated with the physical movement (block 1203).

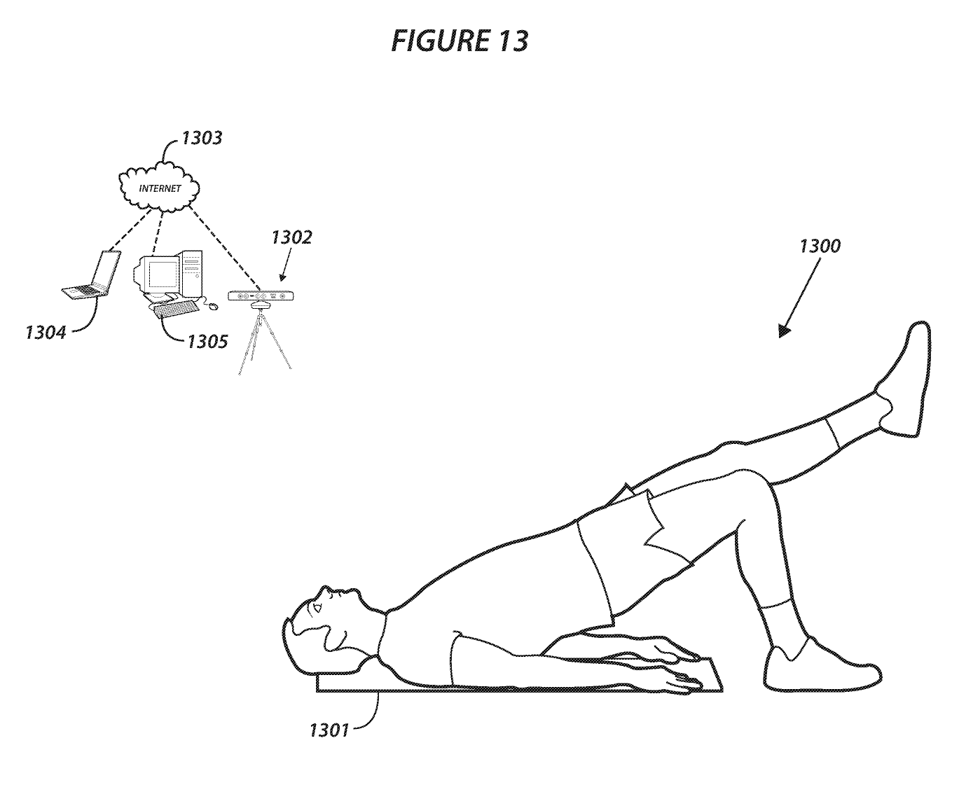

FIG. 13 is an illustration of an individual 1300 receiving feedback from motion-sensing device console 1310 during physical therapy. In some implementations, motion-sensing device console 1310 may be used to provide individual feedback in response to the individual's 1300 execution of various rehabilitation routines.

It should be understood that the present invention may also be adaptable to provide individuals with feedback in response to the individual's execution of fitness exercises. For instance, if motion-sensing device console 1310 detects that a user is doing a particular fitness exercise incorrectly, the device console 1310 can output a visual or audible signal to indicate such (e.g., audible alert indicative of disapproval).

Contrariwise, when motion-sensing device console 1310 detects that the rehabilitation routine or fitness exercise is being performed correctly, the device console 1310 can emit visual and/or audible output signals. In some embodiments, individual 1300 performs the rehabilitation routine or fitness exercises on a pressure sensing device 1301 or other body-sensing detection devices known in the art. The individual's 1300 movement and associated pressure data may then be digitized and compared with pre-stored digital data associated with the specific exercise (e.g., stored on an external server) at discrete time periods.

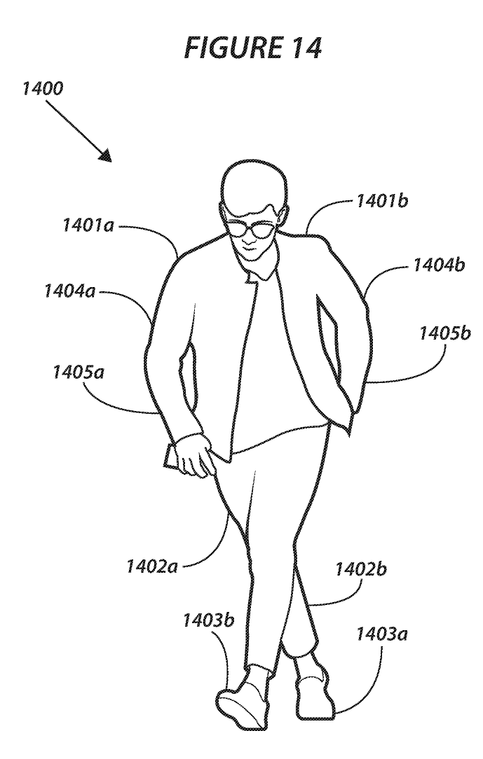

FIG. 14 is an illustration of a walking motion 1400 which may be represented by digital data sets in a manner consistent with the present invention. The present invention may be utilized to learn socially acceptable or trendy body movements. As such, a user may utilize the present invention to improve their social status.

The image of the individual in the figure depicts a “cool” walking motion (e.g., strut) 1400. A motion-sensing device console may track and create digital representations of an individual while attempting to execute the walking motion 1400 which may then be compared to the digital data sets of the correct walking motion 1400.

The motion-sensing device console may track and capture the joint coordinates and/or bone orientation of the individual's shoulders 1401a, 1401b, upper arms 1404a, 1404b, lower arms 1405a, 1405b, upper legs 1402a, 1406a, lower legs 1402b, 1406b, and front feet 1403a, 1403b while attempting to execute the walking motion 1400.

The joint coordinates and/or bone orientations may be tracked at discrete time periods and included within the digital data sets such that other users can mimic walking motion 1400 (or any other walking motion) for acting purposes, to enhance their social status, etc.

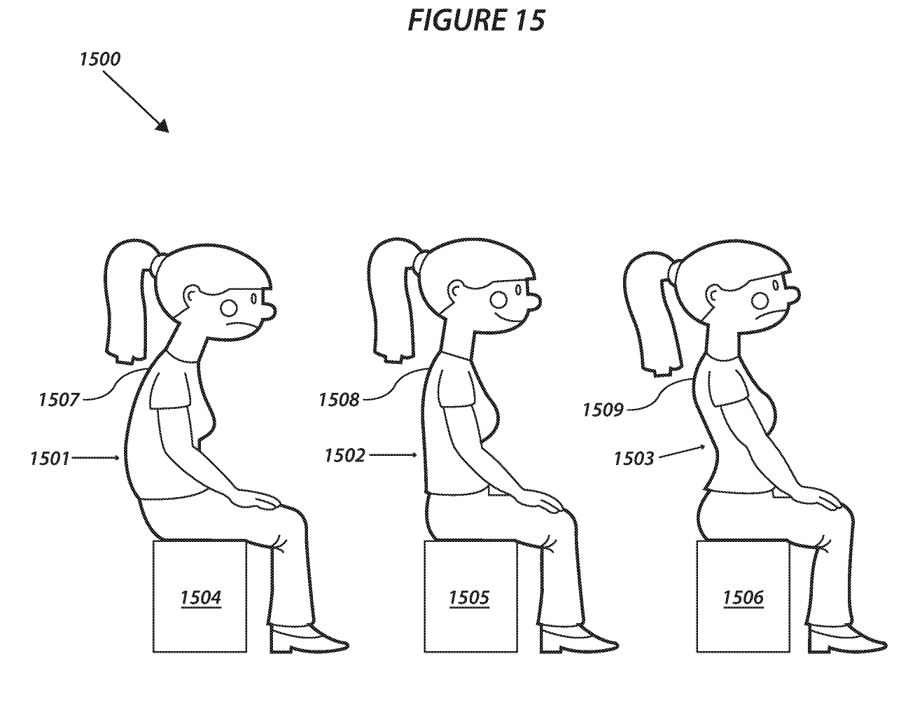

FIG. 15 are illustrations of sitting postures 1500 that are represented by digital data sets in a manner consistent with the present invention. The sitting postures 1500 shown in the figure may be digitized and then compared to digital data sets of correct sitting postures 1500.

The first illustration within FIG. 15 shows the girl seated on a platform 1504. In this illustration, the upper back 1507 and lower back 1501 of the girl is shown to be in an incorrect sitting posture.

The third illustration within FIG. 15 shows the girl seated on platform 1506. As shown, the upper back 1509 and lower back 1503 of the girl is shown to be in an incorrect sitting posture.

In the second illustration, the girl is seated on platform 1505 with correct posture. Noticeably, the girl's upper back 1508 and lower back 1502 are in the correct position such that the girl can maintain correct posture.

Consistent with embodiments of the present invention, a motion-sensing device console can track and capture one's posture, digitize said posture data, compare said data with a plurality of pre-stored digital data associated with correct posture, and based on the comparison, output performance recommendations.

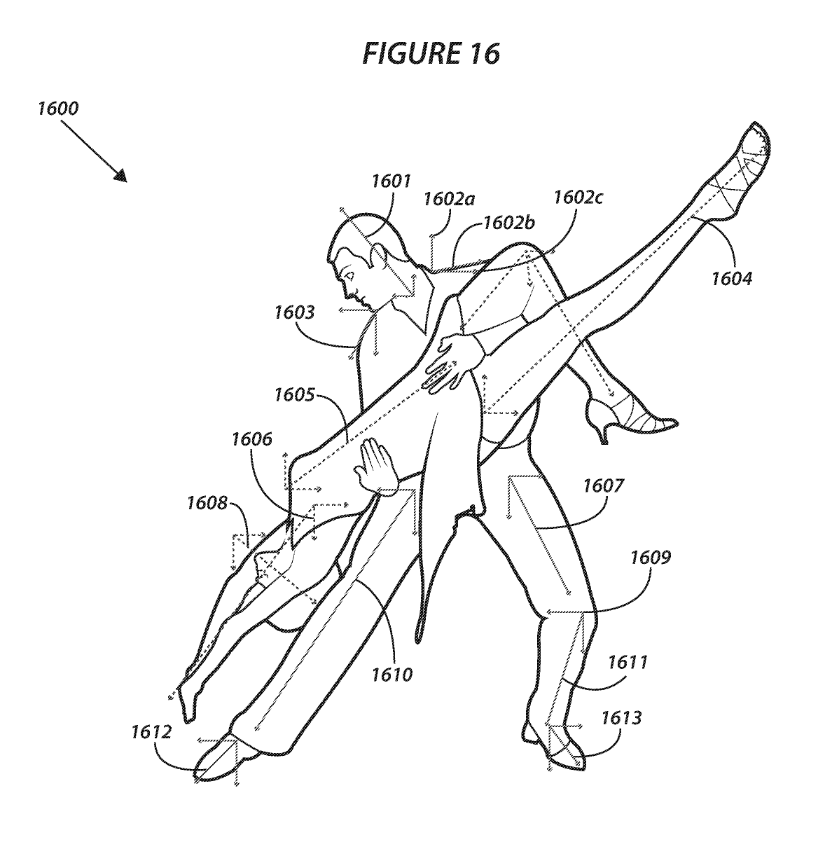

FIG. 16 is an illustration of a pair of dancers in a dance pose 1600 which may be represented by digital data sets consistent with the present invention. As shown in the figure, two dancers (male and female) are shown in a dancer's pose. Noticeably, x-y axes are overlaid on various areas of the male and female dancer during the pose.

For example, an axis 1601 spans the male dancer's neck to the top of the dancer's head (through the male dancer's ear). Horizontal and vertical axes are disposed from the axis 1601 such that the angle that the male dancer's head is disposed may be readily determined.

Many of the male and female dancer's body parts' orientations and dispositions may be tracked and digitized. For example, axis 1602b is disposed at the angle of the left shoulder whereas vertical and horizontal axes 1602a, 1602c are coupled to axis 1602b.

Likewise, arrow 1603 is disposed at the angle of the right shoulder. A motion-sensing device console may therefore be used to detect whether the dancer's shoulders are correctly disposed during the dance routine.

Axis 1607 (which span from the dancer's pelvis to his knee) is disposed along the dancer's upper left leg. The angle of the dancer's upper left leg may be tracked, captured, and digitized such that the dancer can receive feedback from the motion-sensing device console for performance improvement. Likewise, the angle of the male dancer's lower left leg is represented by axis 1611. The angle of the male dancer's left foot may be represented by axis 1613 whereas the angle of the male dancer's right foot may be represented by axis 1612. Finally, FIG. 16 shows that the angle of the male dancer's right leg may be represented by axis 1610 which may be tracked and digitized.

Advantageously, the female dancer's body parts may also be tracked. For example, an axis 1608 may span from the female dancer's chin through her ear to the back of her head to determine whether her head is positioned correctly during the depicted dance pose. Likewise, axis 1606 may reveal the angle that female dancer's arms are disposed during the depicted dance pose.

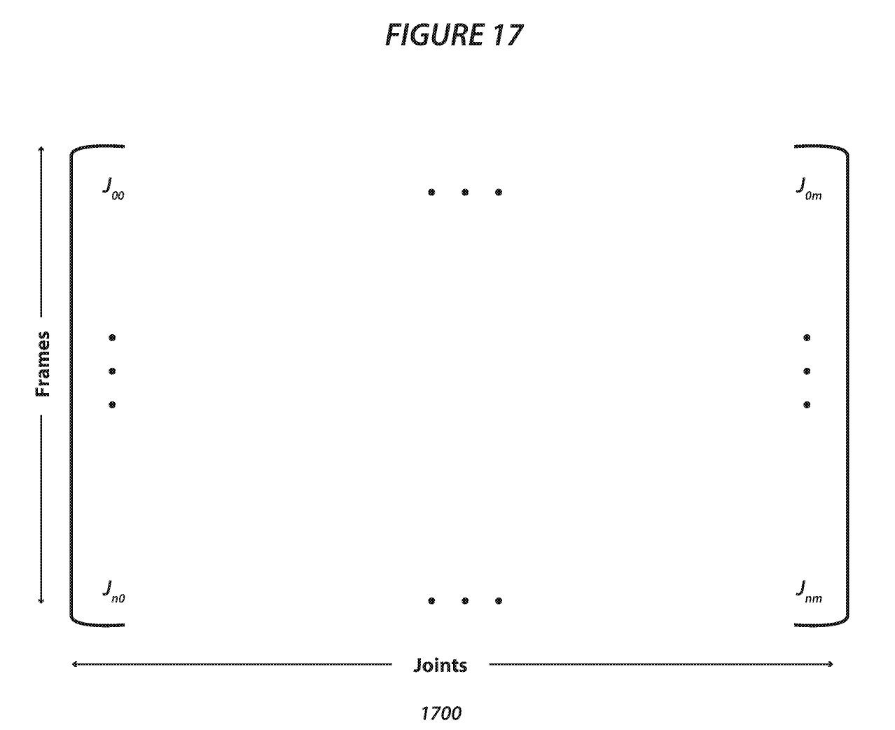

FIG. 17 is an illustration of a data set 1700 associated with a specific physical movement. It should be understood by one having ordinary skill in the art that digital data set 1700 is exemplary and does not unnecessarily limit the present invention. Data set 1700 is a representations of a plurality of joints, relevant to executing the physical movement for a specified activity (e.g., golfing, bowling, shooting a basketball, etc.).

In the embodiment shown, there are “m” number of joints required to execute the physical movement of a given activity. In the figure, J₀₀ represents the joint coordinate(s) or bone orientation(s) associated with a single joint or bone that is required to execute the physical movement for a specific frame or time period. Further, J₀ₘ represents the last joint coordinate or bone orientation associated with the execution of the physical movement for a specified activity in the set for a first time period or frame.

Most importantly, data set 1700 represents the joint coordinate(s) or bone orientation(s) for each frame or time frame during the execution of the specified activity. As such, the last time period or frame for each respective joint coordinate or bone orientation are represented by Jₙ₀-Jₙₘ. Notably, the data in data set 1700 may be digitized and represented as a digital data set as shown in the next figure.

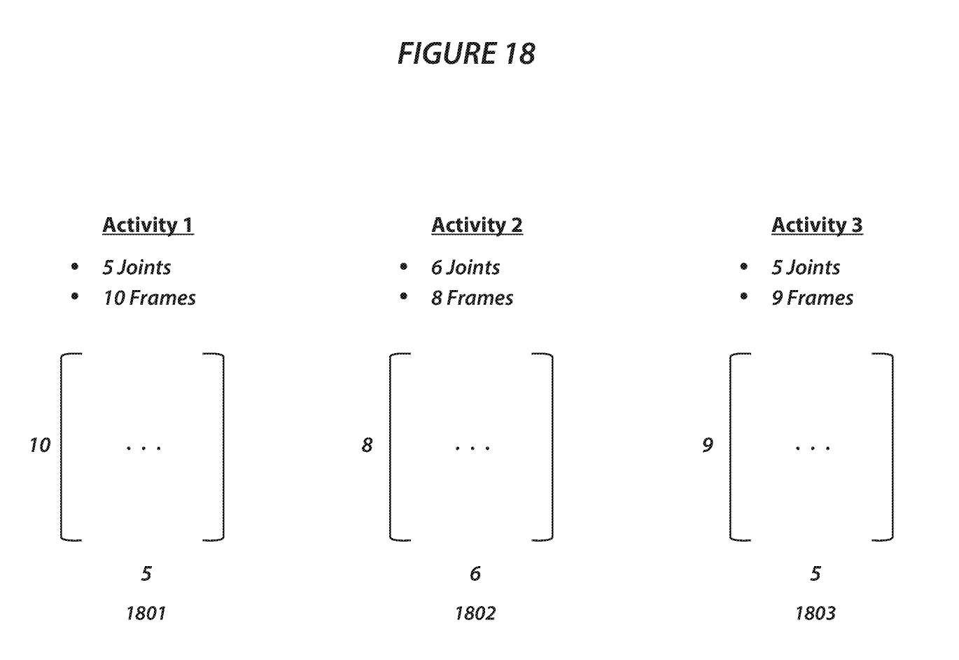

FIG. 18 are illustrations of three representations of digital data sets 1801, 1802, 1803 associated with three exemplary physical activities. For example, Activity 1 can be represented by the precise movement of five joints in ten frames (or time periods). Activity 2 can be represented by the precise movement of eight joints in six frames or time periods. Activity 3 can likewise be represented by the precise movement of five joints in nine frames or time periods.

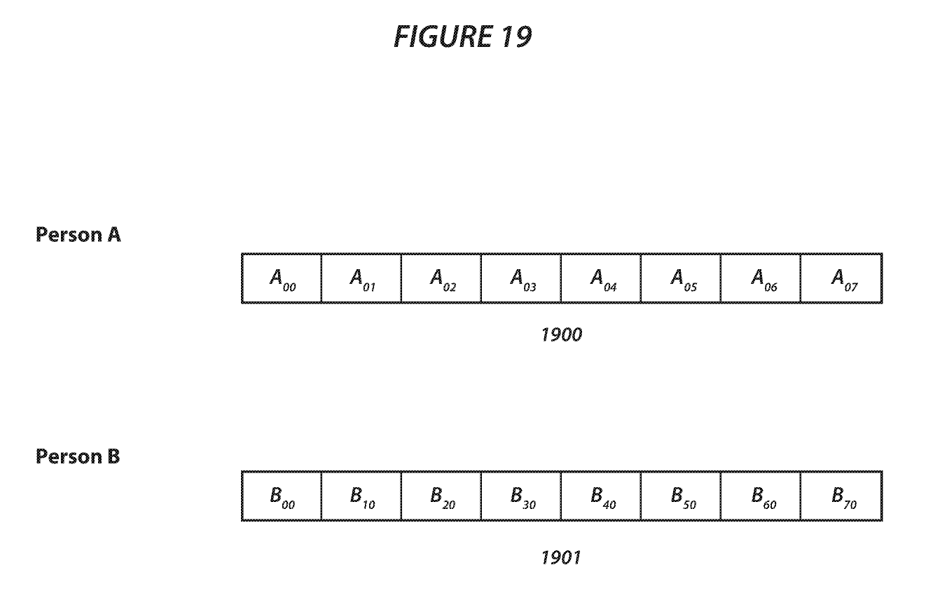

FIG. 19 are illustrations of digital data sets 1900, 1901 associated with the performance of a physical movement executed by a first individual and a second individual. Digital data set 1900 represents the digital data set (for the nth frame) executed by Person A for a physical movement for a specific activity. Digital data set 1901 represents the digital data set (for the nth frame) executed by Person B for the same physical movement for the same activity.

The present invention relates to a system and method of creating and distributing digital data sets to improve performance of physical activities. The present invention includes capturing at least one digital representation of each body position during the execution of an activity. The activity involves one or more physical movements. Converting the at least one digital representation of each body position associated with the activity to digital data sets. The digital data sets comprise joint coordinates or bone orientations at discrete time periods during the execution of the activity.

The present invention further includes identifying and storing the at least one joint coordinate or bone orientation extracted from each digital representation. The activity may be at least one of an athletic movement, fitness exercise, rehabilitation routine, or dance movement. In some embodiments, the athletic movement is at least one of shooting a basketball, swinging a golf club, throwing a football, swinging a baseball bat, walking on a treadmill, or any in-situ human ambulatory movement.

The present invention further includes storing the digital representation of each body position of each body position during the execution of the activity on an external server. In some embodiments, the at least one digital representation of each body position during the execution of the activity are extrapolated from at least one of a still picture or a video stream. In some embodiments, the at least one digital representation is captured using a depth camera.

The present invention includes a method of body-position tracking and processing including parsing body-position tracking data of an activity into a plurality of sequentially-parsed, body position data. Additionally, comparing the plurality of sequentially-parsed body position data to at least one pre-stored digital data set associated with the activity. Based on the comparison, outputting a performance recommendation.

In some embodiments, the at least one pre-stored digital data set represents a closest match to a pre-defined movement in a database. The database may include digital data sets which include one or more joint coordinates or bone orientations associated with one or more individuals performing the activity.

In some embodiments, comparing the plurality of sequentially-parsed, body position data to the at least one pre-stored digital data set includes comparing joint coordinates or bone orientations at discrete time periods during the performed activity. The at least one performance recommendation may include graphics that illustrate an overlay of joint coordinates or bone orientations of the plurality of sequentially-parsed, body-position data and the pre-stored data associated with the performed activity.

In some embodiments, the method may further include outputting a visual or audible signal to indicate whether the activity is being performed correctly.

The present invention further includes a non-transitory machine-readable storage medium including code, when executed, to cause a machine to capture digital representations of one or more joint coordinates or bone orientations associated with an individual during the execution of an activity. The captured digital representations may include a first plurality of digital representations of the individual throughout the execution of the activity and a second plurality of digital representations of the inanimate object throughout the execution of the activity.

Further, code, when executed, to cause a machine to compare the one or more joint coordinates or bone orientations to a plurality of pre-stored joint coordinates or bone orientations associated with the activity. In addition, code, when executed, to cause a machine to compare the kinetic data of the inanimate object throughout the execution of the activity to a plurality of kinetic data to a plurality of pre-stored kinetic data associated with the activity. Based on the comparisons, output a plurality of performance recommendations to indicate whether the activity is being performed correctly.

In some embodiments, the outputted plurality of performance recommendations includes a visual or audible indication.

The present invention includes a non-transitory machine-readable storage medium including code, when executed, to cause a machine to capture a plurality of digital representations of an individual, donned with a measuring device, while executing an. Further, code, when executed, to cause a machine to retrieve data from the measuring device. In addition, code, when executed, to cause a machine to compare the retrieved data to pre-stored measurement data associated with the activity. Based on the comparison, output a plurality of performance recommendations.

The present invention includes a non-transitory machine-readable storage medium including code, when executed, to cause a machine to capture digital representations of an inanimate object while an individual executes an activity.

The present invention as previously described, when executed, to cause a machine to further recapture digital representations of the performed activity into a second plurality of digital representations, compare the second plurality of digital representations to the plurality of pre-stored digital data sets, and based on the comparison, output a second plurality of performance recommendations.

The non-transitory machine-readable storage medium of the previously described including code, when executed to cause a machine to further provide a side-by-side comparison of the digital with the plurality of pre-stored digital data sets.

A present invention includes a non-transitory machine-readable storage medium including code, when executed, to cause a machine to: capture digital representations while an individual executes an activity while handling an inanimate object. The captured digital representations include a first plurality of digital representations of the individual throughout the execution of the activity and a second plurality of digital representations of the inanimate object throughout the execution of the activity.

In addition, the non-transitory machine-readable storage medium includes code to identify joint coordinates and/or bone orientations of the individual from the first plurality of digital representations; compare the kinetic data of other inanimate objects during the execution of the activity; and based on the comparisons, output a plurality of performance recommendations to indicate whether the activity is being performed correctly.

The present invention includes a non-transitory machine-readable storage medium including code, when executed, to cause a machine to capture digital representations of an inanimate object while an individual executes an activity. The inanimate object includes a plurality of sensors to retrieve kinetic data of the inanimate object during the execution of the activity. Additionally, code, when executed, to cause a machine to compare the retrieved kinetic data to a plurality of pre-stored kinetic data whereas based on the comparison, output a plurality of performance recommendations.

The present invention includes a non-transitory machine-readable storage medium including code, when executed, to cause a machine to employ a device to retrieve data during the execution of an activity while an individual is in physical contact with the device. The device comprises a plurality of sensors which measure one or more physical attributes. In addition, including code, when executed, to cause a machine to compare the retrieved data to a plurality of pre-stored data whereas based on the comparison, output a first plurality of performance recommendations.

The retrieved data may include pressure data. In addition, code, when executed, to convert the digital representations of joint coordinates and/or bone orientations to digital data sets. The digital data sets comprise joint coordinates and/or bone orientations at discrete time periods during the execution of the activity.

The non-transitory machine-readable storage medium further comprises code, when executed, to compare the retrieved data to pre-stored measurement data associated with the activity.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in some embodiments” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

The preceding Description and accompanying Drawings describe examples of embodiments in some detail to aid understanding. However, the scope of protection may also include equivalents, permutations, and combinations that are not explicitly described herein. Only the claims appended here (along with those of parent, child, or divisional patents, if any) define the limits of the protected intellectual-property rights.

1. A method, comprising:
capturing at least one digital representation of each body position during an execution of an activity;
wherein the activity involves one or more physical movements; and
converting the at least one digital representation of each body position associated with the activity to a digital data set;
wherein the digital data set comprises at least one joint coordinate or bone orientations at discrete time periods during the execution of the activity.

2. The method of claim 1 further comprising identifying and storing the at least one joint coordinates or bone orientations extracted from each digital representation.

3. The method of claim 1, wherein the activity is at least one of an athletic movement, fitness exercise, rehabilitation routine, or dance movement.

4. The method of claim 1 further comprising comparing the digital data set associated with the captured digital representation of the executed activity to at least one pre-stored digital data set associated with the executed activity.

5. The method of claim 1 further comprising storing the digital representation of each body position during the execution of the activity on an external server.

6. The method of claim 1, wherein the at least one digital representation of each body position during the execution of the activity is extrapolated from at least one of a still picture or a video stream.

7. The method of claim 1, wherein the at least one digital representation of each body position is captured using a depth camera.

8. A method of body-position tracking and processing, comprising:
parsing body-position tracking data of an activity into a plurality of sequentially-parsed, body position data;
comparing the plurality of sequentially-parsed, body position data to at least one pre-stored digital data set associated with the activity;
based on the comparison, outputting at least one performance recommendation.

9. The method of claim 8, wherein the at least one pre-stored digital data set represents a closest match to a pre-defined movement in a database.

10. The method of claim 8, wherein the database includes a plurality of digital data sets;
wherein the plurality of digital data sets include one or more joint coordinates or bone orientations associated with one or more individuals performing the activity.

11. The method of claim 8, wherein comparing the plurality of sequentially-parsed, body-position data to the at least one pre-stored digital data set includes comparing one or more joint coordinates or bone orientations at discrete time periods during the performed activity.

12. The method of claim 8, wherein the at least one performance recommendation includes graphics that illustrate an overlay of one or more joint coordinates or bone orientations associated with the plurality of sequentially-parsed, body-position data with the pre-stored data associated with the performed activity.

13. The method of claim 8 further comprising outputting a visual or audible signal to indicate whether the activity is performed correctly.

14. A non-transitory machine-readable storage medium including code, when executed, to cause a machine to:
capture digital representations of one or more joint coordinates or bone orientations associated with an individual during the execution of an activity;
wherein the captured digital representations include a first plurality of digital representations of the individual throughout the execution of the activity and a second plurality of digital representations of the inanimate object throughout the execution of the activity;
compare the one or more joint coordinates or bone orientations to a plurality of pre-stored joint coordinates or bone orientations associated with the activity;
compare kinetic data of the inanimate object throughout the execution of the activity to a plurality of kinetic data to a plurality of pre-stored kinetic data associated with the activity;
based on the comparisons, output a plurality of performance recommendations to indicate whether the activity is being performed correctly.

15. The non-transitory machine-readable storage medium of claim 14, wherein the outputted plurality of performance recommendations includes a visual or audible indication.

16. A non-transitory machine-readable storage medium including code, when executed, to cause a machine to:
capture digital representations of a plurality of joint coordinates or bone orientations associated with an individual donned with a measuring device during the execution of an activity;
retrieve data from the measuring device;
compare the retrieved data to a plurality of pre-stored measurement data associated with the activity; and
based on the comparison, output a first plurality of performance recommendations.

17. The non-transitory machine-readable storage medium of claim 16, wherein the retrieved data includes pressure data.

18. The non-transitory machine-readable storage medium of claim 16 further comprising code, when executed, to convert the digital representations of one or more joint coordinates or bone orientations to digital data sets;
wherein the digital data sets comprises digital representations of the one or more joint coordinates or bone orientations at discrete time periods during the execution of the activity.

19. The non-transitory machine-readable storage medium of claim 18 further comprising code, when executed, to compare the retrieved data to the plurality of pre-stored measurement data associated with the activity.

20. The non-transitory machine-readable storage medium of claim 19, wherein based on the comparison, output a second plurality of performance recommendations.
